(19) United States
(12) Patent Application Publication
(10) Pub. No.: US 2012/0007826 A1
(43) Pub. Date: Jan. 12, 2012

(54) TOUCH-CONTROLLED ELECTRIC APPARATUS AND CONTROL METHOD THEREOF

(75) Inventor: YU ZHENG, SHANGHAI (CN)

(73) Assignees: MITAC RESEARCH (SHANGHAI) LTD., SHANGHAI (CN); MITAC INTERNATIONAL CORP., TAOYUAN (TW)

(21) Appl. No.: 13/008,545

(22) Filed: Jan. 18, 2011

(30) Foreign Application Priority Data
Jul. 9, 2010 (TW) 099122767

(51) Int. Cl. G06F 3/045; G06F 3/041

(52) U.S. Cl. 345/174; 345/173

(57) ABSTRACT

A touch-controlled electronic apparatus and a touch control method thereof are disclosed. The touch-controlled electronic apparatus includes a touch screen and a control module. The touch screen detects a plurality of touch points at where an object touches the touch screen. The control module is electrically connected to the touch screen and defines a coordinate system based on the touch screen. The control module computes an angle contained between the movement direction of the object and a coordinate axis of the coordinate system to obtain a representative angular value. When the representative angular value matches one of a plurality of first angular values preset in the coordinate system, the control module generates a control signal based on the representative angular value and the object movement speed, so that the touch screen executes operations corresponding to the control signal.

### FIELD OF THE INVENTION

The present invention relates to a touch-controlled electronic apparatus and a touch control method thereof; and more particularly to an electronic apparatus having a touch screen and a touch control method thereof.

### BACKGROUND OF THE INVENTION

Following the introduction of the iPhone into market by Apple, Inc. in 2007 and the introduction of the Windows 7 into market by Microsoft Corporation in 2009, the technique of touch screen once again attracts the attention of people at every corner in the world. As a result, the application of touch gestures is now gradually known and accepted among users.

Currently, the Windows CE series are operating systems developed by Microsoft Corporation particularly for the embedded platform. The Windows CE series are characterized in their small volume and fast booting time, and can therefore be used with systems that have a central processing unit having relatively low computing performance and a relatively small memory.

Products in the Windows CE series earlier than Windows CE 5.0 and Windows Embedded CE 6.0 R3 do not support the touch gesture function on a touch screen. However, since it brings users with great convenience and fun in using electronic apparatus, the touch gesture function is currently implemented by mounting it onto the Graphics, Windowing and Events Subsystem (GWES). In other words, it is the touch driver of the GWES that obtains touch points created in a slide movement according to the user's touch gesture on the touch screen and then computes the sliding direction and speed. The above design has the following disadvantages:

(1) The touch driver will largely filter the touch points on the touch screen. Therefore, there are times the touch points sent to the GWES are not sufficient for the application programs at an upper layer to compute the slide movement direction and speed.

(2) The application programs obtain the touch points via the GWES instead of directly from the touch driver. Therefore, the efficiency in computing and performing corresponding operations is low.

(3) Since the application programs of different operating system versions have different ways of recognizing and implementing touch gestures, there is no way for uniformly defining the behaviors and standards of touch gestures.

### SUMMARY OF THE INVENTION

A primary object of the present invention is to provide a touch-controlled electronic apparatus and a touch control method thereof.

To achieve the above and other objects, the touch control method according to the present invention is applicable to a touch-controlled electronic apparatus having a touch screen and a control module electrically connected to the touch screen, and includes the following steps: using the control module to define a coordinate system based on the touch screen, the coordinate system presetting a plurality of directions, and an angle contained between each of the directions and an coordinate axis of the coordinate system being defined as a first angular value; using the touch screen to detect a plurality of touch points at where an object touches the touch screen; using the control module to compute an angle contained between each of any two adjacent touch points and the coordinate axis of the coordinate system to obtain a plurality of second angular values; computing an average of the plural second angular values to obtain a representative angular value; computing a movement speed of the object based on a distance difference and a time difference between any two adjacent touch points; using the control module to determine whether the representative angular value matches any one of the first angular values of the coordinate system; and in the case the representative angular value matching one of the plural first angular values of the coordinate system, using the control module to generate a control signal based on the movement speed and the representative angular value.

In the present invention, the coordinate system includes two coordinate axes, namely, an x-axis and a y-axis. And, the step of computing the second angular values of any two adjacent touch points further includes the following steps: queuing the touch points in the sequence of timestamps of the touch points; and computing the plural second angular values based on an x-axis difference and a y-axis difference between any two adjacent touch points.

The step of computing the representative angular value further includes the following steps: excluding the largest and the smallest one of the second angular values, and computing the average of the remaining second angular values to obtain the representative angular value.

In the present invention, the touch screen is selected from the group consisting of a capacitive touch screen, a resistive touch screen, and an infrared touch screen.

To achieve the above and other objects, the touch-controlled electronic apparatus according to the present invention includes a touch screen and a control module electrically connected to the touch screen. The control module includes a coordinate processing unit, a direction recognition unit, and a speed unit. The coordinate processing unit defines a coordinate system based on the touch screen, the coordinate system has a plurality of preset directions, and an angle contained between each of the plural directions and a coordinate axis of the coordinate system is defined as a first angular value, so that a plurality of different first angular values are defined. The direction recognition unit computes an angle contained between each of any two adjacent touch points and the coordinate axis to obtain a plurality of second angular values, and computes an average of the plural second angular values to obtain a representative angular value. The speed unit computes a movement speed of the object based on a distance difference and a time difference between any two adjacent ones of the plural touch points. When the representative angular value matches any one of the plural first angular values as preset in the coordinate system for the plural directions, the control module generates a control signal based on the representative angular value and the movement speed.

In the present invention, the direction recognition unit queues the touch points in the sequence of timestamps thereof, and then computes the plural second angular values based on an x-axis difference and a y-axis difference between any two adjacent touch points.

In computing the second angular values, the direction recognition unit excludes the largest and the smallest one of the plural second angular values and then computes an average of the remaining second angular values to obtain the representative angular value.

In an embodiment of the present invention, the coordinate system includes two coordinate axes, namely, an x-axis and a y-axis, and is a relative coordinate system.

In another embodiment of the present invention, the coordinate system includes two coordinate axes, namely, an x-axis and a y-axis, and is an absolute coordinate system.

In the present invention, the touch screen can be a capacitive touch screen, a resistive touch screen, or an infrared touch screen.

With the above arrangements, the touch-controlled electronic apparatus and the touch control method thereof according to the present invention is advantageous in that:

The control module generates the control signal based on the object movement speed on the touch screen and the representative angular value, so that the touch screen executes operations corresponding to the control signal and enables a user to perform touch control at an increased speed.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a configuration block diagram of a touch-controlled electronic apparatus according to the present invention;

FIG. 2 is a system layer diagram of a touch-controlled electronic apparatus according to an embodiment of the present invention;

FIG. 3 shows an embodiment of a coordinate system defined by a coordinate processing unit included in the touch-controlled electronic apparatus of the present invention;

FIG. 4 is a diagram showing coordinates of different touch points plotted according to an embodiment of the touch-controlled electronic apparatus of the present invention;

FIG. 5A schematically shows a “slide picture” gesture as a first exemplified touch control manner provided by the touch-controlled electronic apparatus of the present invention;

FIG. 5B schematically shows a “turn picture” gesture as a second exemplified touch control manner provided by the touch-controlled electronic apparatus of the present invention;

FIG. 5C schematically shows a “magnify picture” gesture as a third exemplified touch control manner provided by the touch-controlled electronic apparatus of the present invention;

FIG. 5D schematically shows a “reduce picture” gesture a fourth exemplified touch control manner provided by the touch-controlled electronic apparatus of the present invention; and

FIG. 6 is a flowchart showing the steps included in a touch control method applicable to a touch-controlled electronic apparatus according to the present invention.

### DETAILED DESCRIPTION OF THE PREFERRED EMBODIMENTS

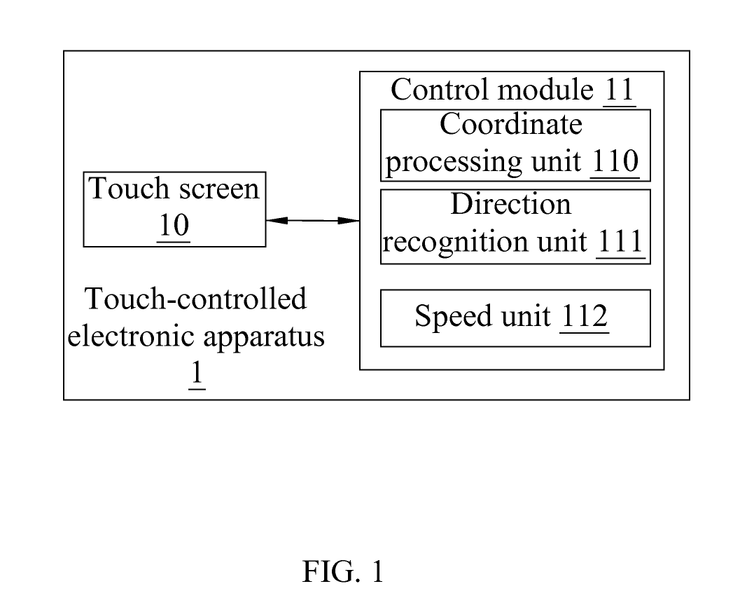

Please refer to FIG. 1 that is a configuration block diagram of a touch-controlled electronic apparatus 1 according to the present invention. As shown, the touch-controlled electronic apparatus 1 includes a touch screen 10 and a control module 11 electrically connected to the touch screen 10. The control module 11 further includes a coordinate processing unit 110, a direction recognition unit 111, and a speed unit 112. The coordinate processing unit 110 defines a coordinate system based on the touch screen 10. The coordinate system includes two coordinate axes, namely, an x-axis and a y-axis, and can be a relative coordinate system, an absolute coordinate system, or a combination thereof. When a user performs a touch gesture on the touch screen 10, the touch screen 10 is able to detect a plurality of touch points created by the touch gesture. Then, the direction recognition unit 111 receives the plural touch points transmitted thereto by the touch screen 10 in order to compute a movement direction of the touch gesture, and computes a representative angular value based on an angle contained between the touch gesture movement direction and one of the coordinate axes. For example, the representative angular value can be computed as a function of an angle contained between the touch gesture movement direction and the x-axis. When the representative angular value matches one of many angular values preset by the coordinate system, the speed unit 112 will then compute a movement speed of the touch gesture based on a distance difference and a time difference between any two adjacent touch points. Finally, the control module 11 generates a control signal based on the representative angular value and the touch gesture movement speed, so that the touch screen 10 is caused to execute operations corresponding to the control signal.

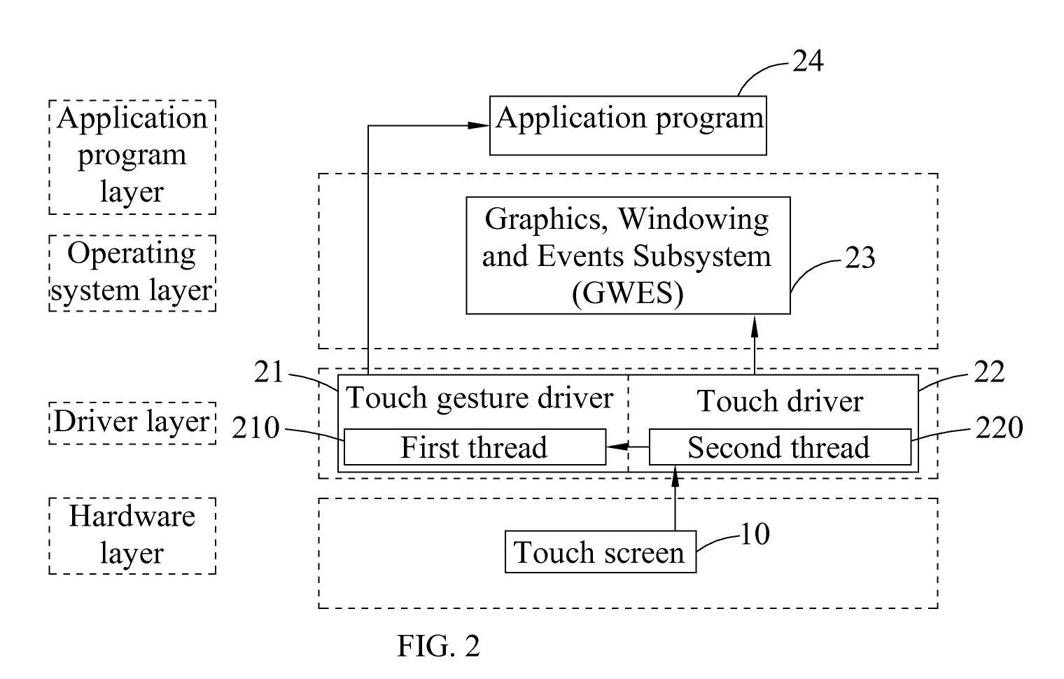

Please refer to FIG. 2 that is a system layer diagram of a touch-controlled electronic apparatus according to an embodiment of the present invention. When the touch-controlled electronic apparatus runs under the Windows CE operating system environment, the control module 11 is implemented by combining a touch gesture driver 21 and a touch driver 22. The touch gesture driver 21 includes a first thread 210, and the touch driver 22 includes a second thread 220. The first thread 210 receives from the second thread 220 a touch message transmitted by the touch screen 10, such as, for example, “finger touches” or “finger removed”. The touch screen 10 can be a capacitive touch screen, resistive touch screen, or an infrared touch screen. When a user's finger touches the touch screen 10, the second thread 220 immediately records the touch point on the touch screen 10 and a timestamp thereof created by the touch. When the user's finger is moved away from the touch screen 10, the second thread 220 stops recording and sends the already recorded touch points and the timestamps thereof to the first thread 210. After receiving the touch points and the timestamps thereof transmitted by the second thread 220, the first thread 210 starts recognizing the touch points and makes determination. After completion of the recognition and the determination, the first thread 210 directly generates a control signal to an application program 24, so that the application program 24 skips over the Graphics, Windowing and Events Subsystem (GWES) 23 to directly execute operations corresponding to the control signal.

Accordingly, the touch-controlled electronic apparatus 1 of the present invention can operate and compute at an increased rate. Further, since it is not necessary to filter and sample the touch points with the GWES 23, the touch gesture can be recognized in upgraded efficiency. Meanwhile, the problem of differently defined touch gesture behaviors and standards among different operating systems can be solved, so that the gesture behaviors can be actively and flexibly defined according to customer's actual need.

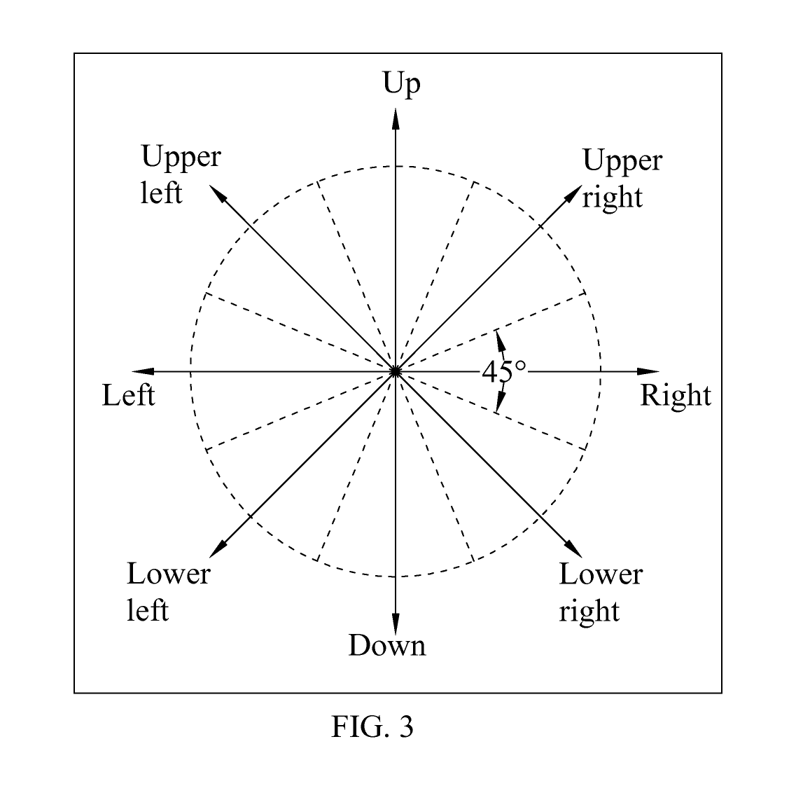

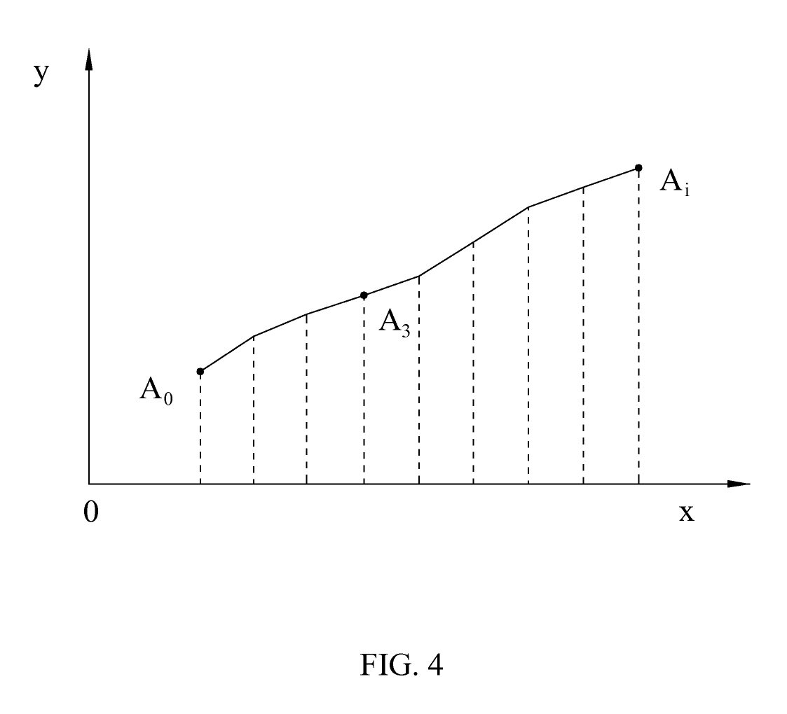

Please refer to FIGS. 1 and 3 at the same time. FIG. 3 shows an embodiment of a coordinate system defined by the coordinate processing unit 110 in the touch-controlled electronic apparatus 1 of the present invention. The coordinate processing unit 110 defines a coordinate system based on the touch screen 10; and the coordinate system includes two coordinate axes, namely, an x-axis and a y-axis, to define eight different directions, namely, right, upper right, up, upper left, left, lower left, down, and lower right. Each of the eight directions corresponds to a different first angular value. The coordinate system can be a relative coordinate system or an absolute coordinate system. That is, when the coordinate system is a relative coordinate system, a beginning point at where the user's finger touches the touch screen 10 is used as an origin of the coordinate system, and other coordinates are transmitted to the direction recognition unit 111 for recognition and determination. And, when the coordinate system is an absolute coordinate system, the point on the touch screen 10 touched by the user's finger has a pair of fixed coordinate values. Please refer to FIG. 4 that is a diagram showing coordinates of different touch points plotted according to an embodiment of the touch-controlled electronic apparatus of the present invention. When the number of touch points on the touch screen 10 is “i”, and the touch points are separately recorded as A₀, . . . A₃, . . . Aᵢ and marked on the coordinate system in the sequence of the timestamps of the touch points. Then, the direction recognition unit 111 computes the finger's movement direction. That is, the direction recognition unit 111 computes an angle contained between each of any two adjacent touch points and the x-axis to obtain a second angular value for each of the contained angles, and computes an average of the second angular values of all the contained angles to obtain the finger's movement direction, as expressed in the following formulas:

Δyᵢ=(A_{iy}−A_{(i-1)y});

Δxᵢ=(Aᵢₓ−A₍ᵢ₋₁₎ₓ);

where, Δxᵢ is an x-axis difference, and Δyᵢ is a y-axis difference.

In the Windows CE operating system, the second angular value Angleᵢ of the contained angle is computed using the following function:

Angleᵢ=α tan 2(Δyᵢ, Δxᵢ);

To minimize the error, the direction recognition unit 111 will exclude the largest angular value Angleₘ and the smallest angular value Angleₙ in the process of computing the average of the second angular values to obtain a representative angular value AverageAngle, as expressed below:

AverageAngle=(Angle₁+Angle₂+ . . . +Angleᵢ−Angleₘ−Angleₙ)/(i−3);

Thereafter, the direction recognition unit 111 determines whether the representative angular value AverageAngle matches the first angular value of any one of the eight directions defined by the coordinate processing unit 110. In the case the representative angular value AverageAngle matches the first angular value of one of the eight directions, the speed unit 112 will compute a finger movement speed Δvᵢ using the following formulas:

Δsᵢ=Δxᵢ*Δxᵢ+Δyᵢ*Δyᵢ;

Δtᵢ=Δtᵢ−Δt₍ᵢ₋₁₎;

Δvᵢ=sqrt(Δsᵢ)/Δtᵢ;

where, Δsᵢ is a distance difference between any two adjacent touch points, and Δtᵢ is a time difference between any two adjacent touch points.

To minimize the error, the largest speed Δₘ and the smallest speed Δvₙ are excluded in computation, so as to obtain an average speed AverageSpeed, as expressed in the following formula:

AverageSpeed=(Δv₁+Δv₂+ . . . +Δvᵢ−Δvₘ−Δvₙ)/(i−2);

Finally, the control module 11 generates a control signal as a function of the average speed AverageSpeed and the representative angular value AverageAngle:

PostMessage(HWND_BROADCAST, WM_TOUCH_GESTURE, TGesture.Angle, TGesture.Speed);

When the application program 24 receives the control signal, it will execute operations corresponding to the control signal.

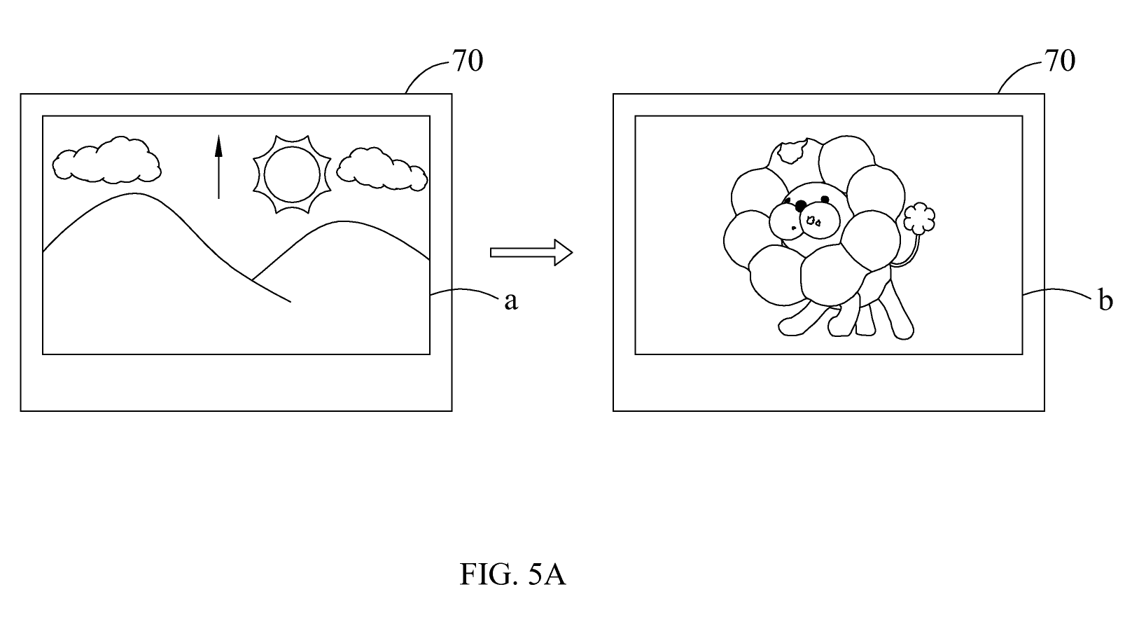

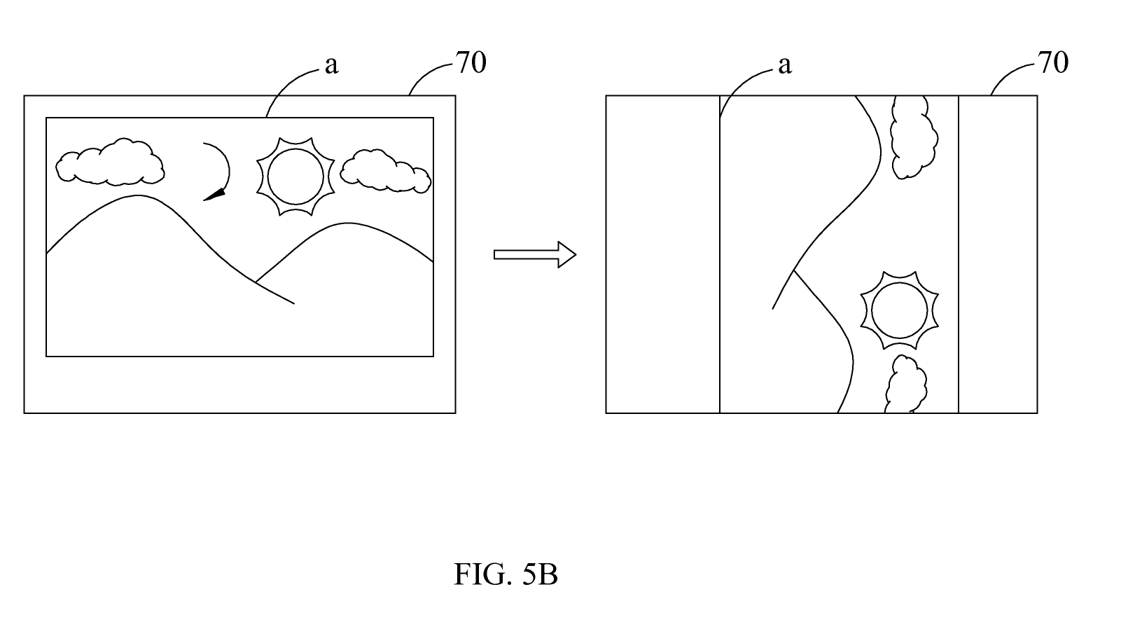

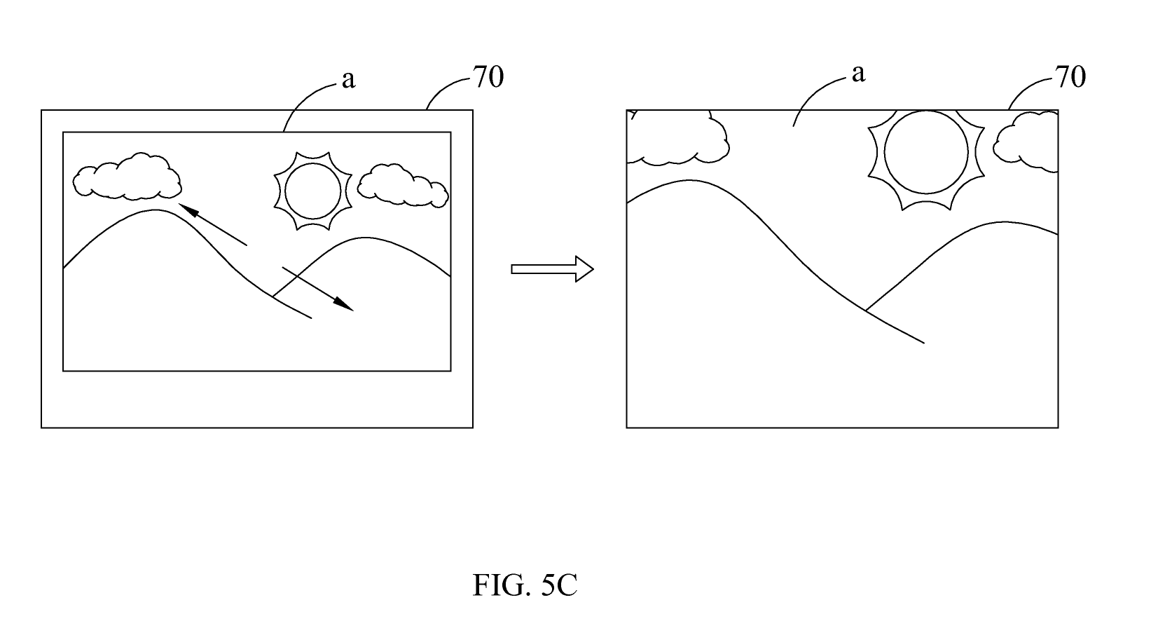

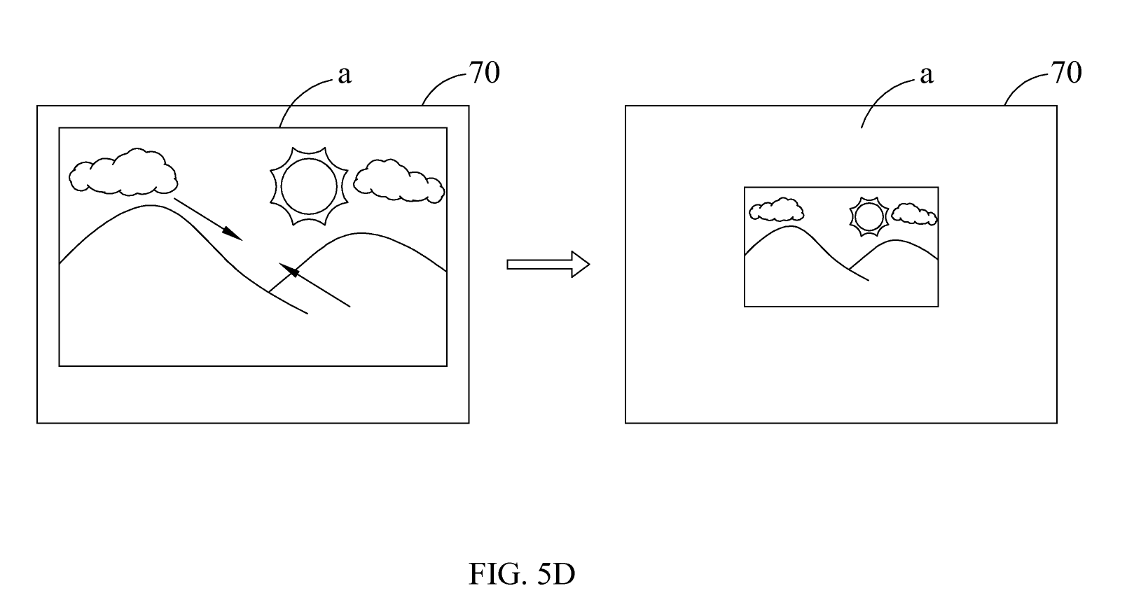

Please refer to FIG. 5A that schematically shows a “slide picture” gesture as a first exemplified touch control manner provided by the touch-controlled electronic apparatus of the present invention. In the first touch control manner, a user slides a finger upward on a picture “a” displayed in a touch screen 70. A plurality of touch points created by this touch gesture will be transmitted by the touch screen 70 to the control module. The direction recognition unit in the control module computes the finger movement direction. That is, the direction recognition unit uses the above-mentioned function to compute the second angular values based on the angle contained between each of any two adjacent touch points and the x-axis, and then excludes the largest and the smallest second angular value to compute the representative angular value. In the case the representative angular value matches the first angular value of any one of the eight directions as defined by the coordinate processing unit in the coordinate system, such as the up direction in this example, indicating the touch gesture is an upward sliding gesture, the control module will then generate a control signal based on the finger movement direction and movement speed, so that the application program executes operations corresponding to the control signal. That is, to shift the picture “a” upward and display the next picture “b” in the touch screen 70.

Please refer to FIG. 5B that schematically shows a “turn picture” gesture as a second exemplified touch control manner provided by the touch-controlled electronic apparatus of the present invention. In the second touch control manner, a user presses two fingers against the touch screen 70 and turns a picture “a” displayed in the touch screen 70. A plurality of touch points created by this touch gesture will be transmitted by the touch screen 70 to the control module. The direction recognition unit in the control module computes the finger movement direction and recognizes the touch gesture is a clockwise turning gesture. The control module then generates a control signal for the application program to execute operations corresponding to the control signal; that is, to correspondingly turn the picture “a” clockwise.

Please refer to FIG. 5C that schematically shows a “magnify picture” gesture as a third exemplified touch control manner provided by the touch-controlled electronic apparatus of the present invention. In the third touch control manner, a user presses two fingers against a picture “a” displayed in the touch screen 70 and then separates the two fingers from each other. A plurality of touch points created by this touch gesture will be transmitted by the touch screen 70 to the control module. The direction recognition unit in the control module computes the finger movement directions and recognizes the touch gesture includes two finger gestures that move outward in two different directions. The control module then generates a control signal for the application program to execute operations corresponding to the control signal; that is, to correspondingly magnify the picture “a” to an extent according to the distance between the two separated fingers.

Please refer to FIG. 5D that schematically shows a “reduce picture” gesture as a fourth exemplified touch control manner provided by the touch-controlled electronic apparatus of the present invention. In the fourth touch control manner, a user presses two fingers against a picture “a” displayed in the touch screen 70 and then moves the two fingers toward each other. A plurality of touch points created by this touch gesture will be transmitted by the touch screen 70 to the control module. The direction recognition unit in the control module computes the finger movement directions and recognizes the touch gesture includes two finger gestures that move inward in two different directions. The control module then generates a control signal for the application program to execute operations corresponding to the control signal; that is, to correspondingly reduce the picture “a” to an extent according to the distance between the two fingers approached to each other.

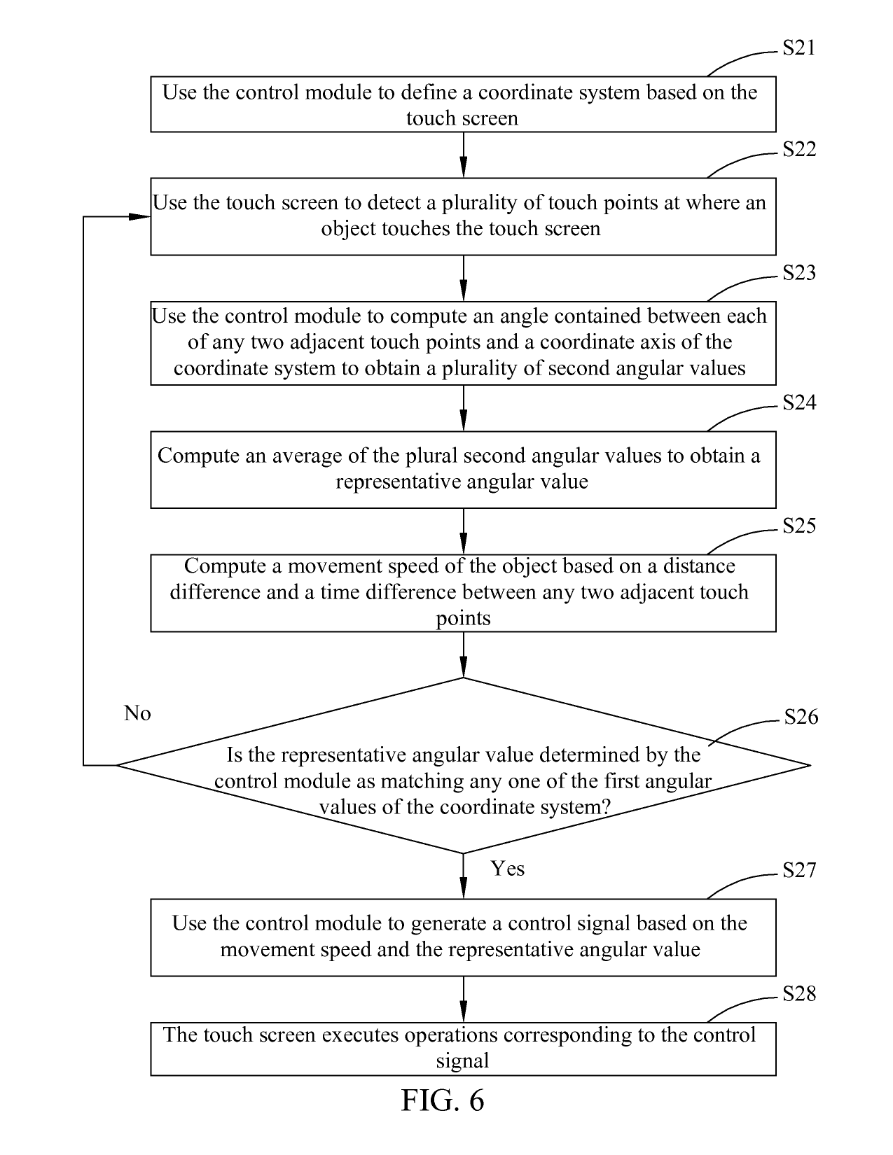

FIG. 6 is a flowchart showing the steps included in a touch control method applicable to a touch-controlled electronic apparatus according to the present invention. The method includes the following steps:

S21: using a control module to define a coordinate system based on a touch screen. The coordinate system includes two coordinate axes, namely, an x-axis and a y-axis, and further defines a plurality of directions, each of which corresponds to one of a plurality of different first angular values.

S22: using the touch screen to detect a plurality of touch points at where an object touches the touch screen. The touch screen can be a capacitive touch screen or a resistive touch screen.

S23: using the control module to compute an angle between each of any two adjacent touch points and one of the two coordinate axes of the coordinate system to obtain a plurality of second angular values.

The step S23 of computing the second angular values of any two adjacent touch points further includes the following steps: queuing the touch points in the sequence of the timestamps of the touch points; and computing a plurality of second angular values based on an x-axis difference and a y-axis difference between any two adjacent touch points.

S24: computing an average of the plural second angular values to obtain a representative angular value.

S25: computing a movement speed of the object based on a distance difference and a time difference between any two adjacent touch points.

S26: using the control module to determine whether the representative angular value matches any one of the first angular values of the coordinate system. If the representative angular value matches one of the first angular values of the coordinate system, the method goes to a step S27; or if not, the method goes to the step S22.

S27: using the control module to generate a control signal based on the movement speed and the representative angular value.

S28: the touch screen executing operations corresponding to the control signal.

The step S24 of computing the representative angular value further includes the following steps: excluding the largest and the smallest one of the second angular values, and computing the average of the remaining second angular values to obtain the representative angular value.

In brief, the touch-controlled electronic apparatus uses the touch screen thereof to detect touch points on the touch screen, and uses the control module to compute the object movement direction and speed based on the touch points, so that an application program can be used to directly execute corresponding operations. Therefore, the operating process in the prior art that must be performed via the GWES is simplified to allow users to operate the touch-controlled electronic apparatus in a highly efficient manner.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A touch control method applicable to a touch-controlled electronic apparatus, the touch-controller electronic apparatus including a touch screen and a control module electrically connected to the touch screen; the touch control method comprising the following steps:
using the control module to define a coordinate system based on the touch screen, the coordinate system presetting a plurality of directions, and an angle contained between each of the directions and an coordinate axis of the coordinate system being defined as a first angular value;
using the touch screen to detect a plurality of touch points at where an object touches the touch screen;
using the control module to compute an angle contained between each of any two adjacent touch points and the coordinate axis of the coordinate system to obtain a plurality of second angular values;
computing an average of the plural second angular values to obtain a representative angular value;
computing a movement speed of the object based on a distance difference and a time difference between any two adjacent touch points;
using the control module to determine whether the representative angular value matches any one of the first angular values of the coordinate system; and
in the case the representative angular value matching one of the plural first angular values of the coordinate system, using the control module to generate a control signal based on the movement speed and the representative angular value.

2. The touch control method applicable to a touch-controlled electronic apparatus as claimed in claim 1, wherein the coordinate system includes two coordinate axes, namely, an x-axis and a y-axis; and wherein the step of computing the second angular values of any two adjacent touch points further includes the following steps: queuing the touch points in the sequence of timestamps of the touch points; and computing the plural second angular values based on an x-axis difference and a y-axis difference between any two adjacent touch points.

3. The touch control method applicable to a touch-controlled electronic apparatus as claimed in claim 1, wherein the step of computing the representative angular value further includes the following steps: excluding a largest and a smallest one of the second angular values, and computing an average of the remaining second angular values to obtain the representative angular value.

4. The touch control method applicable to a touch-controlled electronic apparatus as claimed in claim 1, wherein the touch screen is selected from the group consisting of a capacitive touch screen, a resistive touch screen, and an infrared touch screen.

5. A touch-controlled electronic apparatus, comprising:
a touch screen for detecting a plurality of touch points at where an object touches the touch screen; and
a control module being electrically connected to the touch screen, and including:
a coordinate processing unit for defining a coordinate system based on the touch screen; the coordinate system having a plurality of preset directions, and an angle contained between each of the plural directions and a coordinate axis of the coordinate system being defined as a first angular value, so that a plurality of different first angular values are defined;
a direction recognition unit for computing an angle contained between each of any two adjacent touch points and the coordinate axis to obtain a plurality of second angular values, and computing an average of the plural second angular values to obtain a representative angular value; and
a speed unit for computing a movement speed of the object based on a distance difference and a time difference between any two adjacent ones of the plural touch points;
whereby when the representative angular value matches any one of the plural first angular values as preset in the coordinate system for the plural directions, the control module generates a control signal based on the representative angular value and the movement speed.

6. The touch-controlled electronic apparatus as claimed in claim 5, wherein the direction recognition unit queues the touch points in the sequence of timestamps thereof, and then computes the plural second angular values based on an x-axis difference and a y-axis difference between any two adjacent touch points.

7. The touch-controlled electronic apparatus as claimed in claim 5, wherein the direction recognition unit excludes a largest and a smallest one of the plural second angular values and then computes an average of the remaining second angular values to obtain the representative angular value.

8. The touch-controlled electronic apparatus as claimed in claim 5, wherein the coordinate system includes two coordinate axes, namely, an x-axis and a y-axis, and is a relative coordinate system.

9. The touch-controlled electronic apparatus as claimed in claim 5, wherein the coordinate system includes two coordinate axes, namely, an x-axis and a y-axis, and is an absolute coordinate system.

10. The touch-controlled electronic apparatus as claimed in claim 5, wherein the touch screen is selected from the group consisting of a capacitive touch screen, a resistive touch screen, and an infrared touch screen.
